(19) United States
(12) Patent Application Publication
(10) Pub. No.: US 2003/0050986 A1
(43) Pub. Date: Mar. 13, 2003

(54) System and method for community interfaces

(76) Inventors: Charles R. Matthews, Paradise Valley, AZ (US); Steven Truong, Goodyear, AZ (US)

Correspondence Address: SNELL & WILMER, ONE ARIZONA CENTER, 400 EAST VAN BUREN, PHOENIX, AZ, 850040001

(21) Appl. No.: 10/243,374

(22) Filed: Sep. 13, 2002

Related U.S. Application Data
(60) Provisional application No. 60/323,170, filed on Sep. 13, 2001.

(51) Int. Cl. G06F 15/16; G06F 17/00

(52) U.S. Cl. 709/206; 707/104.1; 345/963

(57) ABSTRACT

Systems and methods are configured for providing enhanced functionality for communication between members of a community and/or groups within the community. A member of a community may access a web page. The web page may be customizable for the member. The web page may assist the member in subscribing to groups associated with the community. Subscription to a group automatically populates the member's personal calendar with events from the group's calendar. Subscription to a group automatically causes group email messages to be sent to the member. Subscription to a group automatically causes group alert messages to be sent to the member. These alerts may be displayed on the web page.

### CROSS-REFERENCE TO RELATED APPLICATIONS

This application claims priority to, and the benefit of, U.S. Provisional Application serial No. 60/323,170, entitled “SYSTEM AND METHOD FOR COMMUNITY INTERFACES,” filed Sep. 13, 2001, which is incorporated herein by reference.

### FIELD OF INVENTION

The present invention generally relates to community interface and network systems, and more particularly, to systems and methods for administrating and networking of community members.

### REFERENCE TO COMPUTER PROGRAM LISTING

A computer program listing appendix is submitted herewith on compact disc (“CD”). The computer program listing is contained in multiple files, as described in the attached transmittal, which are stored on a single compact disc. The file creation dates and sizes are also included in the attached transmittal. For example, the file “application.cls” was created on Aug. 5, 2002 at 5:01 PM and is 231,265 bytes in size. The CD was created on Sep. 13, 2002. A copy CD is also included herewith for a total of two CDs. The computer program listing appendix, as recorded on the compact disk, is incorporated herein by reference.

### BACKGROUND OF THE INVENTION

Various systems have been used to enhance interaction and the distribution of information among people, groups of people, businesses, and other entities, wherein the distribution generally comprises the sharing of information, coordination of schedules, and/or the like. The interaction and distribution of information within communities has been enhanced through the use of newspapers that include editorials, community calendars, news stories, want ads, show-times at the local theater, and the like, wherein the newspapers may have a national, state, or local scope. Furthermore, businesses sometimes distribute an internal newsletter that may serve to distribute information and enhance interaction between the business' employees.

Electronic technology has also been employed to distribute information and enhance interaction between members of a community. For example, email and telephone systems may be configured to disseminate information to community members. Often, in these systems, a distribution list can be created to simplify simultaneous delivery of information to more than one individual. In another example, web sites provide information to a vast audience. In that regard, a business may use a company web site (internal or external) for dissemination of information relevant to its employees.

Various electronic calendar applications are also available to help an individual schedule the use of their time. For example, programs exist that allow an individual to schedule an event for a group which may involve the steps of broadcasting an event to the group, and waiting for the members of the group to accept or confirm attendance. Such a broadcasting email may announce an event, and the event may be added to a user's personal calendar when the user accepts the invitation to the event. Other systems for group interaction and distribution of information may involve news flashes that are communicated to members of the group. For example, a radio or TV may transmit a news flash directly to various homes, or an individual may send an email to the computers of various recipients. Unfortunately, these news flashes may be missed if individuals are not watching the TV at the right moment or do not check their email regularly.

Despite the existence of systems for distributing information and enhancing interaction discussed above, there continues to be a need for new systems and methods to enhance interaction between members of a community. A need exists for new methods of subscribing and unsubscribing to groups within a community. A need also exists for new methods of managing groups, emailing group members, providing news flashes to group members, and/or coordinating calendars. Furthermore, a need exists to improve access to information which may currently be dispersed among various web sites.

### SUMMARY OF THE INVENTION

Systems and methods are configured to provide enhanced functionality for communication between members of a community and/or groups within the community. A member of a community may access a customizable web page, wherein the web page may assist the member in subscribing to groups associated with the community. In accordance with another exemplary embodiment of the present invention, subscription to a group automatically populates the member's personal calendar with events from the group's calendar. In yet another exemplary embodiment, subscription to a group automatically enters the member onto the group email distribution to allow group email messages to be sent to the member. In another exemplary embodiment, subscription to a group automatically causes group alert messages to be sent to the member, wherein the alerts may be displayed on the web page.

### BRIEF DESCRIPTION OF THE DRAWINGS

A more complete understanding of the present invention may be derived by referring to the detailed description and claims when considered in connection with the figures, wherein like reference numbers refer to similar elements throughout the figures, and:

FIG. 1 illustrates a block diagram overview of an exemplary community resource management system in accordance with an exemplary embodiment of the present invention;

FIG. 2 illustrates an exemplary host system in accordance with an exemplary embodiment of the present invention;

FIG. 3 illustrates a community resource management method in accordance with an exemplary embodiment of the present invention;

FIG. 4 illustrates an exemplary groups web page in accordance with an exemplary embodiment of the present invention;

FIG. 5 illustrates an exemplary home page in accordance with an exemplary embodiment of the present invention; and

FIG. 6 illustrates an exemplary marketplace web page in accordance with an exemplary embodiment of the present invention.

### DETAILED DESCRIPTION OF EXEMPLARY EMBODIMENTS

While the exemplary embodiments herein are described in sufficient detail to enable those skilled in the art to practice the invention, it should be understood that other embodiments may be realized and that logical and structural changes may be made without departing from the spirit and scope of the invention. Thus, the following detailed description is presented for purposes of illustration only and not of limitation.

In accordance with one aspect of the present invention, systems and methods are configured to enhance communications between members of a community and/or groups. In an exemplary embodiment of the present invention, systems and methods are configured to manage groups within a community. Furthermore, in another aspect of the present invention, community interaction is encouraged by the relative ease of connecting with other members and groups. For example, systems are configured to simplify subscribing to one or more groups within a community. In an exemplary community reserve management (“CRM”) system, groups within a community are created and presented to members. The systems may allow a member of a community to subscribe to and unsubscribe from one or more of the groups.

In one exemplary embodiment, the CRM systems include a calendar program configured to automatically populate a member's personal calendar with events that are associated with the calendar of the group(s) to which the member is subscribed. In another exemplary embodiment, the system may be configured to automatically provide to the member any email and/or alert messages that are associated with a group to which the member is subscribed. These and other functionalities may be combined in other exemplary embodiments of the present invention. For example, the system may be configured such that the single step of subscribing to a group causes the user to be automatically included on the group's emails and alerts and causes the personal calendar of the member to be automatically populated with the group events of that group.

In general, a user on a user computer communicates with a host server that is configured to enhance interaction between members and groups within a community. As used herein, the terms “user”, “end user”, “consumer”, “customer”, “group” or “member” may be used interchangeably with each other, and each shall mean any person, family, entity, machine, hardware, software and/or business. Furthermore, the terms “business” or “merchant” may be used interchangeably with each other and shall mean any person, entity, machine, hardware, software and/or business.

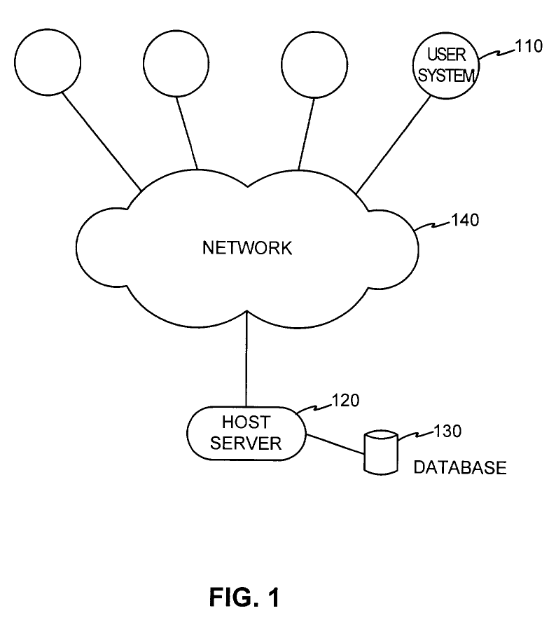

FIG. 1 illustrates an exemplary community resource management system (“CRM system”) 100. CRM system 100 comprises a user system 110, a host server 120, a database 130, and a network 140. CRM system 100 is configured such that a user, on user system 110, may access host server 120 via network 140. Host server 140 is configured to communicate with database 130 and to enhance interaction between users as described herein. In one exemplary embodiment of the present invention, the CRM systems and methods may be implemented as computer software modules loaded onto host server 120. In this exemplary embodiment, user system 110 may not require any CRM specific software to participate in the online community interaction supported by CRM system 100.

In general, host server 120 is configured to interact with a user on a user system 110 and to provide information to user system 110. Interaction with the user may take place via one or more web pages supported by host server 120. Host server 120 is configured to enable administration of member accounts and/or group accounts. For example, host server 120 may be configured to create members within a community, create groups within a community, save and retrieve attributes associated with the members/groups, and/or allow personalization of web pages for each member. Host server 120 may additionally be configured to present to users a list of groups available for subscription/unsubscription, and to subscribe/unsubscribe users upon a valid request. Other functions that are performed by host system 120 may include providing a personal calendar, providing a group calendar, populating a personal calendar with group calendar events, providing email, sending email messages to members of a group, presenting alerts to group members, and/or providing access to homeowner's association documents. Host server 120 may save data to and retrieve data from database 140. In addition, security functions and other monitoring functions may be provided by host server 120.

Host server 120 has a computing unit implemented in the form of a computer-server, although other implementations are possible. The host server may comprise a computing center such as a main frame computer. However, the host computing center may be implemented in other forms, such as a mini-computer, a PC server, a network set of computers, or the like. Host server 120 and/or other computing systems may include a processor for processing digital data, a memory coupled to said processor for storing digital data, an input digitizer coupled to the processor for inputting digital data, an application program stored in said memory and accessible by said processor for directing processing of digital data by said processor, a display coupled to the processor and memory for displaying information derived from digital data processed by said processor, and/or one or more databases, the databases including member attributes data, group attributes data, administration data and/or like data that may be used in association with the present invention.

Furthermore, host server 120 may be configured to provide a suitable web site or other Internet-based graphical user interface which is accessible by users. In one embodiment, the Internet Information Server, Microsoft Transaction Server, and/or Microsoft SQL Server, are used in conjunction with the Microsoft operating system, Microsoft NT web server software, a Microsoft SQL database system, and/or a Microsoft Commerce Server. Additionally, components such as Access or SQL Server, Oracle, Sybase, Informix MySQL, Intervase, etc., may be used to provide an ADO-compliant database management system. The term “web page” as it is used herein is not meant to limit the type of documents and applications that might be used to interact with the user. For example, a typical web site might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and/or the like.

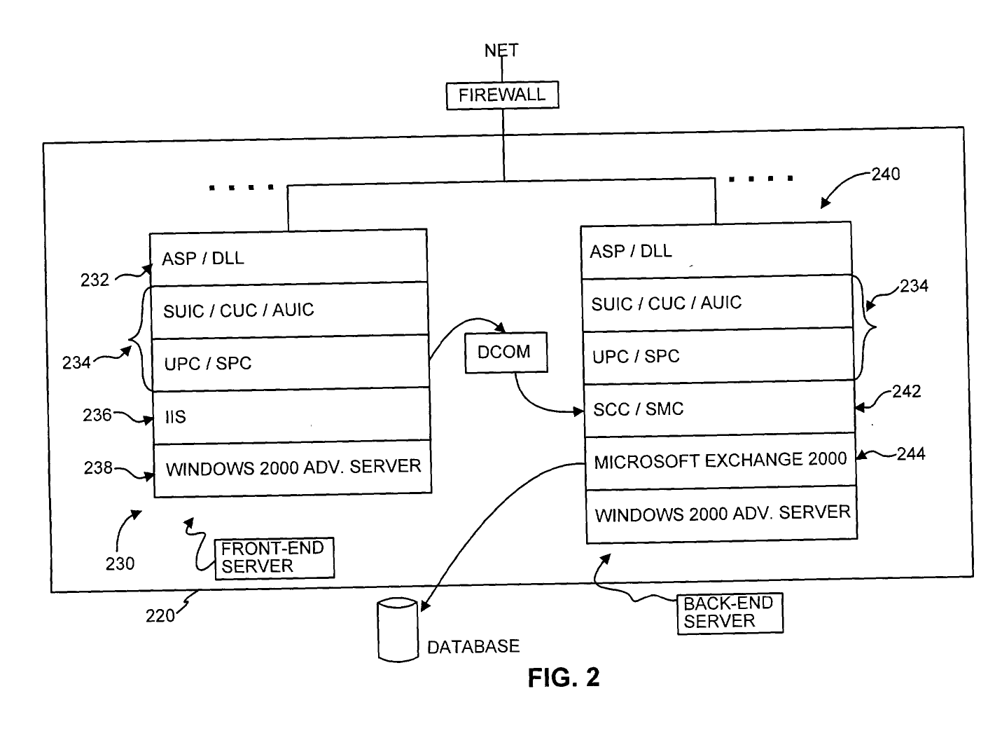

Various host system configurations may perform the functions described herein. FIG. 2 illustrates an exemplary host system 220. Host system 220 may comprise one or more front-end servers 230 and one or more back-end servers 240. Thus, in various exemplary embodiments, the front-end and/or back-end servers may be distributed. Both front-end server 230 and back-end server 240 may comprise various components. For example, the servers may both comprise one or more active server page (“ASP”) and/or dynamic link library (“DLL”) modules 232. The ASP and DLL modules may be configured to present web pages to users, receive inputs from users, and run programs. The user inputs may comprise commands, data, and the like. Typically, front-end server 230 handles the bulk of the web-page interaction with the user, freeing backend server 240 for processing tasks and database interaction.

The servers may also comprise system user interface component (“SUIC”), collaboration user interface component (“CUC”), application user interface component (“AUIC”), user profile component (“UPC”), and/or system profile component (“SPC”) modules 234. Upon user input or program instruction, the SUIC module requests web objects. The web objects may include web pages related to national or community news, weather, sports, customized web objects, and/or the like. The AUIC module may be configured to deliver alerts, news, promotions for businesses, message boards, and/or the like. The CUC module may be configured to deliver mail messages, calendar events, and/or the like. The UPC module may be configured to retrieve and update user profiles. Among other functions, the UPC module may also perform security functions, such as validating the identity of the current login user. The SPC module may be configured to verify that a user has the authority to perform a requested action and to assist in retrieving information from and updating database 130. Front-end server 230 may also comprise an Internet Information Server (“IIS”) module 236 comprising a set of programs for building and administering web sites, and a search engine. IIS module 236 may also provide support for writing web-based applications that access databases.

Back-end server 240 may additionally comprise a system collaboration component (“SCC”), and/or system metadata component (“SMC”) modules 242. The SCC module is configured to perform processing and to interact with the database on collaborative application actions, such as in populating a calendar or creating a mailbox. The SMC module is configured, for example, to create a user and user profile in database 130. Furthermore, back-end server 240 may comprise a Microsoft Exchange 2000 module 244 configured to support such functions as routing, mail, sending, browsing, scheduling, and database functions.

Host server 220 may be built on a Windows 2000 Advanced Server 238 back-bone, with a Microsoft Windows Distributed InterNet Application (“DNA”) and a Microsoft .NET platform. Also, a distributed component object module (“DCOM”) 250 may be configured to facilitate communication between front-end server 230 and back-end server 240. Although one exemplary host server has been described herein, other host server configurations may also be used.

Database 130 is configured to store member attributes and group attributes. Database 130 may be any type of database, such as relational, hierarchical, object-oriented, active directory, and/or the like. Common database products that may be used to implement the databases include DB2 by IBM (White Plains, N.Y.), any of the database products available from Oracle Corporation (Redwood Shores, Calif.), Microsoft Access or MSSQL by Microsoft Corporation (Redmond, Wash.), or any other database product. A database may be organized in any suitable manner, including as data tables or lookup tables. For security and other reasons, any databases, systems, or components of the present invention may consist of any combination of databases or components at a single location or at multiple locations. Furthermore, each database or system may include any of various suitable security features, such as firewalls, access codes, encryption, de-encryption, compression, decompression, and/or the like.

Association of certain data may be accomplished through any data association technique known and/or practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the data tables. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

In accordance with an exemplary embodiment of the present invention, the database includes a member table that lists all of the members and various member attributes. A group table may list all of the groups within a community. Also, a particular group membership table may list all of the members subscribed to a particular group.

Communication between the user and host server 120 is accomplished through any suitable communication means, such as Intranet, Internet, point of interaction device (point of sale device, personal digital assistant, cellular phone, kiosk, etc.), online communications, off-line communications, wireless communications, extranet, WAN, LAN, satellite communications, and/or the like. The network may also be implemented as other types of networks, such as an interactive television (ITV) network. One skilled in the art may appreciate that a network may include any system for exchanging data or transacting business.

The systems may be suitably coupled to the network via data links. A variety of conventional communications media and protocols may be used for data links. For example, a connection to an Internet Service Provider (ISP) over a local loop as is typically used in connection with standard modem communication, cable modem, Dish networks, ISDN, Digital Subscriber Line (DSL), or various wireless communication methods. The user or host system might also reside within a local area network (LAN) which interfaces to a network via a leased line (T1, D3, etc.). Such communication methods are well known in the art and are covered in a variety of standard texts. See, e.g., GILBERT HELD, UNDERSTANDING DATA COMMUNICATIONS (1996), hereby incorporated by reference.

The computing units may be connected with each other via a data communication network. The network may be a public network and assumed to be insecure and open to eavesdroppers. In the illustrated implementation, the network may be embodied as the internet. In this context, the computers may or may not be connected to the internet at all times. For instance, the user computer may employ a modem to occasionally connect to the internet, whereas some members, group administrators or the host server might maintain a permanent connection to the internet. Specific information related to the protocols, standards, and application software utilized in connection with the Internet may not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). All of these texts are hereby incorporated by reference. Moreover, although the invention is frequently described herein as being implemented with TCP/IP communications protocols, the invention could also be implemented using IPX, Appletalk, IP-6, NetBIOS, OSI or any number of existing or future protocols.

User and/or user system 110 may comprise any electronic device that is configured to enable a user to communicate with host server 120. Although user system 110 is described herein in connection with a personal computer, other devices may also be used. For example, user system 110 may comprise laptop computers, notebook computers, hand held computers, personal digital assistants (“PDAs”), IPACs, cellular phones, kiosks, set-top boxes, network computers, workstations, minicomputers, mainframes, and/or the like. These devices may be equipped with wireless technology for enabling access to host server 120. The user computer can be in a home, business, or other environment with access to a network. In an exemplary embodiment, access is through the Internet through a commercially-available web-browser software package. For example, the web-browser software may include Internet Explorer or Netscape.

The users may interact with user system 110 via any input device such as a keyboard, mouse, touch screen, buttons, handheld computer (e.g., Palm Pilot®), cellular phone and/or the like. Similarly, the user computer may typically include an operating system such as any version of Windows, Windows NT/2000/98/95/XP/Millennium, MacOS 9.0, OS/2, BeOS, Linux, UNIX, Solaris, or the like. User system 110 may also include various conventional support software and drivers typically associated with computers.

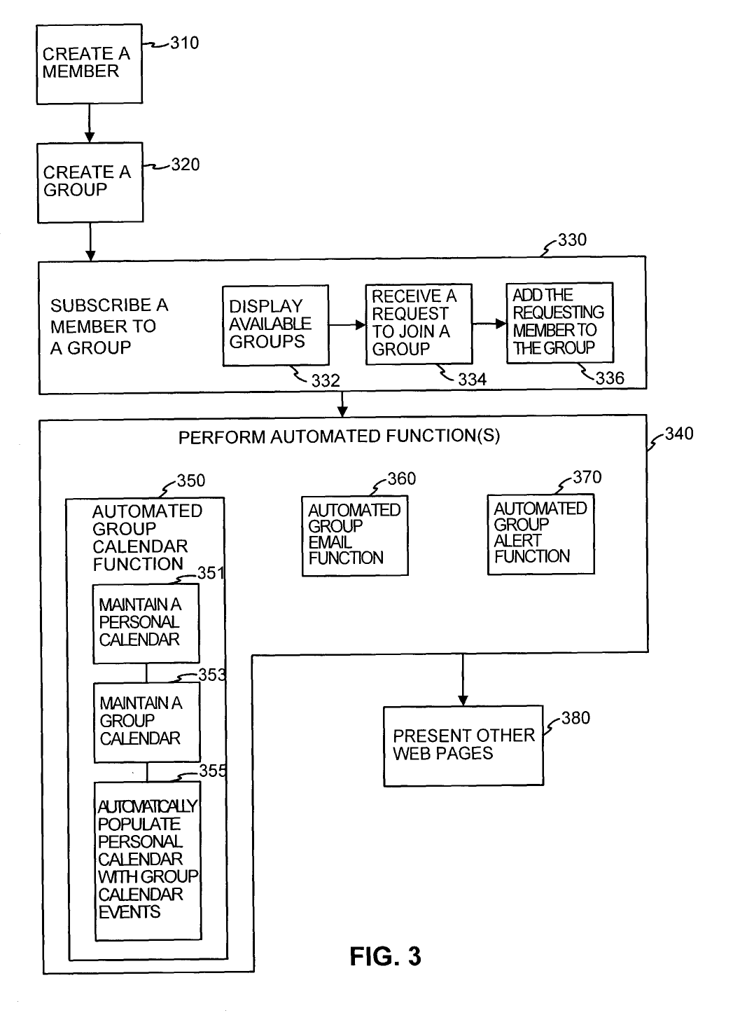

FIG. 3 illustrates an exemplary community resource management (“CRM”) method 300 comprising the steps of: creating a member (Step 310), creating a group (Step 320), subscribing the member to the group (Step 330), and performing one or more automated functions (Step 340). The performing of the automated functions further comprises one or more of the following steps: populating a personal calendar with group events (Step 350), managing email to group members (Step 360), and managing alerts to group members (Step 370). CRM method 300 may further comprise the performance of other functions (Step 380). CRM method 300 is configured to improve interaction between members of a community. In one embodiment, this interaction is enhanced through a user's membership in groups.

A community may consist of any number of users, businesses, or other entities. The community may be defined by any characteristic, such as, for example, any characteristic that gives rise to a reason for the users to associate with each other. In one exemplary embodiment of the present invention, the community is defined as a residential community that is geographically defined. For example, the residential community may include a particular housing development, apartment complex, homeowner's association, municipality, town, or city. However, the community may also be defined as a social community that is defined by common values or beliefs. For example, the community may include people with similar political beliefs, religious beliefs, common cultural backgrounds, or common humanitarian desires. A community may also be defined by employment. For example, the employees of a company may comprise a single community. A community may also be defined based on a common status, such as being a student. For example, all of the students who attend Arizona State University, and/or their alumni, may be defined as a community. Thus, any association of users, businesses, and/or entities may constitute a community. In fact, a community may be defined merely by the association of a number of users.

In accordance with CRM method 300, the user may become a member of the community. In general, creating a member (Step 310) may be accomplished by any method that establishes a user in the CRM system as a member of a particular community. Various exemplary methods of establishing the user as a member of a community are described herein. In one example, a community administrator (“CA”) may create members on the CRM system, as described in further detail below. For example, the CA may create members from particular users identified in the community. All homeowners, for example, within a homeowner's association may be made members of that community when they purchase a home within the association. In another example, the CA may accept requests from users at large to become members of a community and the CA may create members based on those requests. Each community may have one or more CAs. Also, a single CA may oversee several communities. Furthermore, the CA may be automated, for example, wherein approval of membership requests is processed via stored rules. In various embodiments, a member may have the authority to create other members within the same community. This may occur, for example, when parents in a household establish memberships for their spouse and children.

A member is “created” (Step 310) by associating a user with a community. For example, creating a member may include adding the member's name to a community membership list within a database. In other embodiments, the user may be primarily identified by a code and creating a member may include adding the code to a list of member codes in the database. The member's name or code may be associated in database 130 with additional member attributes, such as: member preferences, membership in groups, membership status, member authorizations, and other member attributes. The user may request a specific code and/or password, host system 120 may assign the code and/or password, or they may be created external to CRM system 100.

A “code”, “account number”, or “identifier”, as used herein, includes any device, code, or other identifier/indicia suitably configured to allow the consumer to interact or communicate with the system. The identifier may comprise an account number, card number, the name of an individual, an address, zip code, social security number, authorization/access code, personal identification number (PIN), Internet code, other identification code, any portion of demographic or personal information and/or the like. The code is optionally located on a membership card and/or the like. The code may also be stored on a computer or similar electronic device. Furthermore, the identifier may be encrypted for communication to the host system.

The members may desire to affiliate with one or more groups within their community. Similar to the formation of a community, a group within the community may be defined by any commonly shared characteristic. Exemplary groups include: school groups, such as Mountain Point High School students and/or parents of the students; service organizations, such as Habitat for Humanity or the Red Cross; sports groups, such as fan groups, city leagues, and boosters for particular teams; religious groups; political groups; groups focused on hobbies or talents; book clubs; social groups, such as the YMCA; and/or the like. A group may also include a merchant. Multiple merchants may associate with each other based on commonality of goods or services, alliances or partnerships, or for any other reason. Exemplary merchant groups include grocery stores, restaurants, hair salons, pool related service providers, hardware stores, and landscape service providers. In a business community, exemplary groups include sales, distribution, manufacturing, administration, engineering, and/or the like. In a university environment, exemplary groups include fraternities, clubs, scholastic departments, intercollegiate athletics, alumni associations, and/or the like.

In accordance with another step of CRM method 300, one or more groups are created (Step 320). In one embodiment, a group is created by the CA. For example, a CA may receive a request from a user to form a group within a community. The group requesting user may or may not be a member of the community. The request may be a verbal request or email request to form a group. In another example, the request may be made through a web based form, wherein fields are configured to receive relevant information and to submit the information to the CA.

The CA may evaluate the request to determine whether or not to approve the creation of the new group. For example, requests may be denied to groups sponsoring illegal activity or to groups promoting inappropriate content. Requests may also be denied for persons who have in the past violated community rules. The evaluation of the request may involve any other rules. Furthermore, the evaluation may be an automated process via stored rules. If the CA approves the request, the CA may create or approve the creation of a new group in the community. Creation of a group may occur by adding the group to a list of groups within the community, wherein this list is stored in database 130. Database 130 may also store group attributes.

The group may include a group administrator (“GA”). The GA may take various actions, such as to approve an alert request, to approve events to be placed on the group calendar, and/or to approve/manage email sent to the group. For instance, a member of the group may form an alert request through a web based form, wherein fields are configured to receive relevant information and to submit the information to the GA. The request may be routed to the GA's request queue and then the GA can decide whether to approve/reject the request. If the GA approves the request, the GA may create the requested alert or approve creation of the requested alert so that the alert can be created. Group alerts are further described below. In other embodiments, such requests may be processed by an automated approval process. For example, the approval may be automatically processed by rules established by the GA. For instance, the GA may create a rule allowing all group calendar event requests from a trusted member to be automatically approved.

The GA may also have authority to manage group membership, wherein members may be added to or deleted from a group membership list by the GA. Therefore, GAs may have stored within their member attributes one or more permission indicators that allow them to access such membership lists and to modify the lists. A GA may also have authority to monitor interaction on message boards and/or to remove inappropriate content from the message boards. To remove inappropriate content, the GA can select any items from the message board listing and delete that content. The GA may also monitor message board content by specifying certain keywords, and/or sentences for detecting/monitoring any inappropriate content. In this example, if content added to a message board satisfies the criteria specified by the GA, an alert and/or email message may be sent to the GA to warn of possibly inappropriate content.

Furthermore, the group may be created as a public or private group. A public group is available for any member of the community to join. In contrast, a private group can only be joined by members of the community as approved by the GA. The GA may, for example, restrict access to the group to a predefined list of users. Alternatively, the GA may allow any member to join who attain sufficient qualifications. Generally, a group may be associated with a member of the community, and that member serves as the GA. However, a group may be administered by a non-member of the community. Some groups may be members of multiple communities. When a group is created, host server 120 may cause database 140 to add the new group to a list of groups within the community. Various group attributes may also be stored in database 140.

In accordance with an aspect of the present invention, a member may subscribe to one or more groups. Subscription may take place using any suitable method. For example, subscribing a member to a group (Step 330) may further include the steps of: displaying available groups (Step 332), receiving a request to join a group (Step 334), and adding the requesting member to the group's membership, as described below in more detail (Step 336). In accordance with an exemplary embodiment of the present invention, one or more web pages are configured to display one or more of the groups that exist within that community. (Step 332). A variety of display options may be used and the groups may be listed in various combinations, and layouts. Furthermore, searches and/or filters may assist members in finding a group to join. For example, groups may be listed alphabetically, by topic, in an expandable/collapsible tree-branch format, or as the results of a key-word search.

The groups may be public or private. The group's public/private status may be indicated by a group scope attribute that is specified when the group is created. However, the GA can edit and modify the group's public/private scope if desired. In one example, if the group is defined as a private group, a membership subscription request may first need the approval of the GA. This approval process may also be automated. In another exemplary embodiment, public groups are viewable and can be subscribed to by all members of the community. In another example, a member can join a private group directly if that member is already in the pre-approved members listing which may be predefined by the GA. Alternatively, private groups may not be displayed, may be displayed as unavailable, or may be displayed only to members eligible to join that group. Any other private and/or public display techniques may also be used. For example, the groups may be categorized by type or alphabetically.

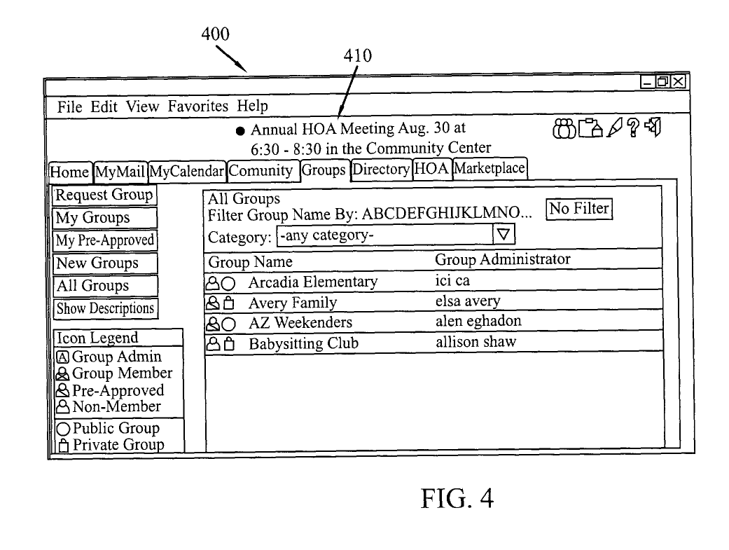

A member may join one or more groups (Step 334) using any group joining technique. In one such technique, the member may be presented with a web page showing a list of groups within the community. FIG. 4 illustrates an exemplary web page 400 offering a list of groups to which a member may subscribe. The member may send a request to join one of the groups by, for example, selecting on a web object. The web object may be a request box, a group name, a radial button, a check box, or the like. Selecting on the web object causes the AUIC module to forward the request to the SPC module, which compares the user's membership attributes to the group's permission criteria to verify whether or not the user has permission to join this group. For example, the SPC module may determine if the group is a private group by looking up the group's public/private attribute in database 130. If the member belongs to the private group or is on the private group's pre-approved member list, the SPC module may instruct the SMC module to add the member to the group member list in database 130. Alternatively, if the member is not on the pre-approved member list, the “join group” request may be routed to a join group request queue and the GA for that group may approve/reject the request. In another embodiment, if the group is a public group, then the SPC module may instruct the SMC module to add the member to the group member list in database 130.

If the user is authorized to join the group, the SPC module instructs the SMC module to update the database. In one exemplary method of updating the database, the SMC module adds an identifier of the member to a table listing the members of that group. Host server 120 may display to the member a list of groups to which the member is subscribed. The currently subscribed groups may be listed by category, alphabetically, or in any other useful format.

In like manner, members may unsubscribe from groups at any time. For example, the user may unsubscribe by selecting on the radial button or check box to remove the subscription indicator. In accordance with an aspect of the present invention, such subscribe and unsubscribe methods are desirably simple and facilitate immediate access to groups within a community.

When a member subscribes to a group or unsubscribes from a group, the system may implement one or more automated processes (Step 340). In the case of a subscribing member, the automated processes include facilitating the user to be automatically included in group functions involving calendar, email, and/or alerts 410 as described in exemplary embodiments herein. In the case of an unsubscribing member, the automated process causes the user to be removed from any group functions. In accordance with an exemplary embodiment of the present invention, in the automated group calendar function, subscribed group events are included on personal calendars (Step 350). The automated group email function includes sending email to subscribed members of the group (Step 360). The automated group alert function comprises displaying alerts to subscribed members of the group (Step 370). Alerts, as described in greater detail below, may be configured to appear on the user's display device (e.g., 410) regardless of whether email, calendar, or other applications of the CRM system are currently being used.

Upon subscribing to a group, the member's personal calendar may automatically be populated with events from the subscribed group calendar. (Step 350). Population of the member's personal calendar may be accomplished using any suitable method; however, in an exemplary embodiment of the present invention, the method includes: maintaining a personal calendar for the member (Step 351), maintaining a group calendar for the group (Step 353), and automatically populating the personal calendar with group events from the group calendar (Step 355).

The functions of maintaining a personal calendar comprising personal events for a member (Step 351) and maintaining a group calendar identifying group events (Step 353) may be performed by host server 120. The calendar programs may be web-based calendars or other suitable calendar programs. Furthermore, the calendar programs may be similar to programs such as the Outlook program. However, in contrast to typical calendar programs, in an exemplary embodiment of the present invention, the personal calendar can be populated with multiple events from another calendar and/or this calendar population may occur without the member first acknowledging a population request.

In one embodiment, each time the member browses to the calendar web page, the host server automatically interrogates the database to retrieve a list of groups to which the member is currently subscribed. The webpage may then poll the calendars of each subscribed group in real time and populate the member's personal calendar with the group events. (Step 355) In other embodiments of the present invention, the method may comprise the steps of exporting/archiving the group calendars to a personal calendar. For example, the member may request archival of group calendar events by selecting on a web object. The web object may be a request box, a group name, a radial button, a check box, or the like. Selecting on the web object may cause the AUIC module to forward the request to the SPC module, which then instructs the SCC module to retrieve all calendar events of groups to which the member is currently subscribed. The SPC module may then save all calendar events into a “snap shot” archived events file to create a “snap-shot” in time of all the group's calendar events. Other methods of retaining group events on a personal calendar may also be used in some embodiments of the present invention.

In various embodiments, only prospective group events are added to the personal calendar. Alternatively, all group events are added to the personal calendar. Furthermore, an unsubscribe request may remove group events from the member's personal calendar. In various embodiments, all the group events are removed or only the prospective group events are removed from the calendar. In one embodiment, events on a personal calendar may be archived from time to time to preserve a record of past events regardless of future unsubscription actions. In yet another example, a family can have a family calendar that is established as a group, i.e. a “family” group. The family calendar events may then populate the personal calendars of all family members in a similar fashion.

Upon joining a group, a member may automatically receive email addressed to the group. (Step 360) In one exemplary embodiment of the present invention, the group is configured with an email address. Each time an email message is sent to the group's email address, the host server looks up the group's membership. For example, the group membership may be listed in a table format in database 130. The corresponding email addresses of each member may also be looked up. The email message may then be forwarded to each member of the group by addressing the email message to the email addresses of the group's members. Thus, the step of unsubscribing from a group causes the member to immediately stop receiving email messages sent to the group. Alternatively, the step of joining a group may cause the new group member's email address to be added to the group's distribution list. In this example, unsubscribing from a group may be configured to automatically remove the user from the email distribution list.

CRM method 300 may involve the use of any suitable email application for sending and receiving email. In one exemplary embodiment, a web-based email application, such as Outlook, is used. In one embodiment, a GA may manage the creation of group emails or may approve group email requests. For example, a group email may be created by a GA and sent to the members of the group. In another embodiment, the members of the group may be authorized to send emails to the group members. In yet another embodiment, any member of the community may send emails to the group members.

CRM method 300, in accordance with another exemplary embodiment of the present invention, may include the step of providing group alerts to any member subscribed to the group sending the alert (Step 370). The alerts are typically short messages that are sent from a group to a member, wherein the member is subscribed in the group. Alerts may be delivered to a member in various ways. In one exemplary alert method, an alert client applet, such as a dynamic HTML object, may cause the alerts to be refreshed after a period of time, e.g., 5 minutes. The alert client applet may be configured to run on the member's machine and to be displayed in conjunction with web pages of this and other systems. The refresh process may involve the web page sending a request to the server (through the AUIC module) that causes the server to look up, in database 120, the groups to which the user is currently subscribed. The server may also be instructed to compile a list of alerts that are currently being published by the groups to which the member is subscribed. These alerts are returned to the user's web page and may be displayed to the member. (Step 370) Thus, unsubscribing from a group causes the member to no longer be sent the alerts from that group. Other methods of delivering an alert to a member may also be used.

A typical alert may automatically appear on the screen of the member's computer regardless of which CRM application is being used at the time (i.e., mail, calendar, news, etc.). Although the alert messages can be located anywhere on the display, in one embodiment the alert messages are presented near a top portion of the screen in a small rectangle. (See FIGS. 4-6.) Alternatively, alert messages may be located in other positions on the screen, including as a pop-up/pop-over windows. The alert may be displayed as a scrolling text box, with alternate cycling of alert text, or using any other suitable display technique.

A GA may manage creation or approval of alerts. For example, an alert may be created when a GA enters: a text message, the duration of the alert, the start time for the alert, the subject of the alert, filtering information, who the alert was created by, and/or the like. The alerts may be deleted from the system when the alerts expire. In another exemplary embodiment, the GA of a home owners association (HOA) group can approve/reject alert requests created by members of the HOA.

In yet another example, a single request to subscribe to a group results in multiple automated functions. For example, a subscribe request may cause both a member's personal calendar to be populated with events from the subscribed group and the member to be included on group distribution of emails and alerts. In this one step subscribe method, a community member selects an object to request membership in a group, the AUIC module passes the request to the SPC module which compares the group's attributes to the member's attributes to verify that the member has permission to join this group. If the member is authorized, the member may be added to a list of the group members in database 130. By being added to the membership list, the member record may be configured, without any additional steps, to have its calendar populated with group events, to receive group emails, and/or group alerts.

This one step subscribe method greatly simplifies the process of becoming integrated within a group in a community. Furthermore, a one step unsubscribe method greatly simplifies severing of ties with community groups. In one exemplary embodiment of the present invention, a single unsubscribe request removes the member from that group's membership list in database 130. Thus, the actions of refreshing the member's calendar and/or refreshing an alert would not find the member on the membership list of the unsubscribed group and would not populate the calendar or provide any alerts from that group. Similarly, in sending an email to the group, because the member's name is no longer associated with the group, no corresponding member email address is returned for the unsubscribed member and that member would not receive email messages from that group. Thus, a single unsubscribe request may stop future alerts and emails from that group as well as instantly removes from the member's personal calendar any group events from that group.

In some instances, a member may desire to not participate in one or more of the above described automated functionalities. To address this need for customization, one or more functionalities can be selectively screened or filtered. The member can customize whether or not they automatically receive information by blocking information on a group by group basis and/or on a class by class basis. For example, a member may select to block the automated population of their personal calendar with group events from the ski club; however, at the same time remain on that group's email distribution list. Conversely, an individual may block the receipt of emails from one or more subscribed groups while continuing to have their personal calendar populated with events from those groups. In another embodiment, personal receipt of group alerts may be selectively activated or deactivated. For each of these functions, the member may select a web object, radial button, check-box, and/or the like to turn on or off the automated calendar population function, group email function, and/or group alert function.

For instance, to disable the automated calendar population function, the member may select a managed calendar web object and select one or more group(s) that the member does not want populating the member's personal calendar. In this example, selecting a suitable “population” web object causes the AUIC module to forward the request to the UPC module to update the member's profile. The member's profile may thus be configured to filter out selected groups from populating the member's personal calendar. In similar fashion, the member can also disable the automated group alert function. In various embodiments, all alerts may be disabled, or selected alerts may be disabled. To disable the group email function, for example, the member may select on a web object which causes the AUIC module to forward a request to the SPC module to remove the member's email address entry from the group distribution list in the database. Internally, the SPC module may instruct the SMC module to perform the update to the database. Alternatively, the member's request to not appear on the group's email distribution may be stored as an attribute of the group and used as a filter when group messages are sent.

Alternatively, a member may join groups without being immediately provided with the interaction functions. These interaction functions may be subsequently activated on a case by case and/or group by group basis. Thus, whether or not the functions are manually or automatically activated, with a single subscription, the user is empowered to use these functions. The activation of selected interaction functions may be stored as part of the member's attributes in database 130.

In accordance with an exemplary embodiment of the present invention, the CRM method may comprise additional steps of customizing (discussed below) and displaying web pages, and displaying a variety of web objects. For example, the member may select various news or sports web objects to be displayed on a personal web page. The member may also custom design web objects for inclusion on the personalized web page. Typically these web objects contain links to other web pages and/or retrieve data from other computers on the internet to complete the display on the member computer.

Another CRM method step may comprise the presentation and management of group message boards. Although message boards are well known, the member's web page may be configured to simplify access to and use of message boards for subscribed groups. For example, access is simplified because the links to the group message boards to which the member belongs can be found located on the same web page or on closely related web pages, thus tending to reduce the time spent navigating to those message boards.

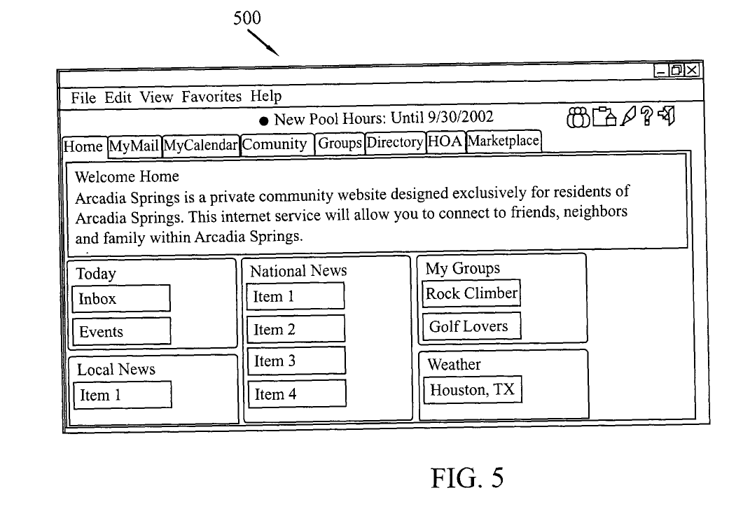

In yet another embodiment, for example in residential applications, new members may automatically be set up with new resident welcome and orientation objects. Also, web objects may exist for community news and events, community services, community information, recreation, and/or community classified ads. FIG. 5 illustrates an exemplary home page 500 with similar information.

In another exemplary CRM embodiment, members of the community may be listed in a community directory. Also, for homeowners associations, a web page may be configured to for displaying important documents such as reports, community management information, by-laws, articles of incorporation, budget materials, meeting minutes, and/or the like. These documents may include Excel, word, PDF, and similar documents. Such a home owners association web page may also be configured to receive maintenance requests.

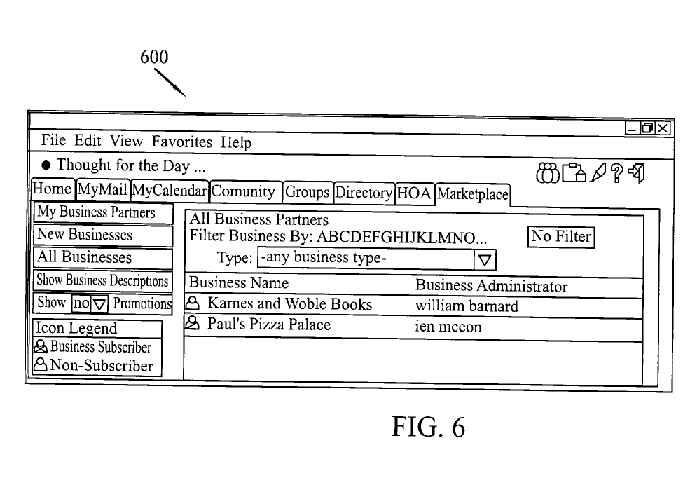

As described above, a merchant may comprise a group. Host server 120 may present to a member a list of merchants. The list of merchants may comprise all merchants in the community, all subscribed merchants, a list of recently added merchants, merchant promotions, and/or the like. The merchants may be presented through a marketplace web page(s). FIG. 6 illustrates an exemplary marketplace web page 600. The marketplace web page may serve as an advertisement forum, business directory, and/or rewards system. One exemplary marketplace web page allows the user to subscribe to merchants and receive advertising that is of interest to the member. Furthermore, merchants can be listed by groups for simplifying the finding of a particular merchant.

In general, the member may be provided with various standard web objects which can be added, for example, by selecting them from a menu of web objects, to a personalized web page. However, web objects may also be custom developed for integrating news, web content, property management systems and processes. Modules such as today's calendar/mail, voting and polls, featured builders and products, my links, search, local weather, stock and business news, local news and other custom developed objects may be created and deployed. In another embodiment, the user may also add, remove, or create objects to customize at the user level. The member can modify the member's web page layout from a customization web-page. Selecting on various web objects on the customization web page causes the SUIC module to instruct the SPC module to update the user interface layout definition in the database.

In accordance with various aspects of the CRM method, members are presented with diverse functionality through a single interface. For example, a home page may include links to separate pages for using different applications. In another example, the various applications are visible as tabs that can be selected to switch between applications. See FIGS. 4-6. Other known and new methods of linking the applications for easy access may be used. The personal layout of the display, the orientation and size of the web objects, other personal preferences, and information about the member may be stored as member attributes in database 140.

The present invention may be described herein in terms of functional block components, optional selections and/or various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and/or the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and/or the like. Still further, the invention could be used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by Mayiam Stalling, published by Prentice Hall; all of which are hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. It should be noted that many alternative or additional functional relationships or physical connections may be present in a practical CRM system.

As may be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In the foregoing specification, the invention has been described with reference to specific embodiments. However, it may be appreciated that various modifications and changes can be made without departing from the scope of the present invention. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

What is claimed is:

1. A method for populating a personal calendar with group events based on subscription to a group, the method comprising the steps of:
receiving a request from a member to join a group;
subscribing said member to the membership of said group;
maintaining a personal calendar for said member, wherein said personal calendar comprises personal events; and
populating said personal calendar of said member with group event information for a group to which said member is subscribed.

2. The method of claim 1 further comprising the step of maintaining a group calendar, wherein said group calendar comprises group events.

3. The method of claim 1 wherein said populating step automatically takes place each time said member accesses said personal calendar.

4. The method of claim 3 wherein said populating step is invoked for a subset of groups to which said member belongs, wherein said subset is selected by said member.

5. The method of claim 4 wherein said member and said group form a part of a residential community.

6. The method of claim 1 wherein said populating step further comprises the steps of:
polling to determine the groups to which said member belongs; and
populating the personal calendar of said member with events from the calendars of the groups to which said member belongs.

7. A method for connecting a community electronically, the method comprising the steps of:
creating at least one member in the community;
storing member attributes in a database, wherein said member attributes include personal preferences for said at least one member;
creating at least one group in the community;
storing group attributes in a database, wherein said group attributes include data regarding membership of said at least one group;
subscribing said at least one member to said at least one group;
maintaining a personal calendar, wherein said personal calendar comprises personal events for said at least one member;
maintaining a group calendar, wherein said group calendar comprises at least one group event for said at least one group; and
populating said personal calendar with said at least one group event for each group to which said at least one member is subscribed.

8. The method of claim 7 wherein said populating step automatically takes place each time said at least one member accesses said personal calendar.

9. The method of claim 8 wherein said populating step is invoked for a subset of groups that said member has selected from among all of said at least one group to which said member is subscribed.

10. The method of claim 7 further comprising the step of automatically providing an alert, associated with said at least one group, to said at least one member.

11. The method of claim 7 further comprising the step of automatically forwarding an email message to said at least one member of said group, wherein said email message was sent to said at least one group.

12. The method of claim 7 wherein said creating steps are performed by a community administrator.

13. The method of claim 7 wherein said subscribing step occurs after a request by said at least one member to join said at least one group.

14. The method of claim 7 further comprising the step of unsubscribing said at least one member from said at least one group upon receipt of an unsubscribe request from said at least one member, wherein after said at least one unsubscribing member, said personal calendar is not populated with said group events.

15. The method of claim 8 further comprising the steps of polling a database to retrieve a list of subscribed groups and retrieving the calendar information from the subscribed groups.

16. The method of claim 7 wherein the community is a residential community.

17. A method for connecting a community electronically, the method comprising the automated steps of:
storing in a database at least one attribute related to a member of said community;
displaying personalized output based on said at least one attribute wherein said
displaying step includes displaying calendars and email;
associating said member with at least one group at the request of said member;
automatically forwarding email from said at least one group to said member;
maintaining a personal calendar, wherein said personal calendar comprises personal events for said member;
maintaining a group calendar, wherein said group calendar comprises at least one group event for said at least one group;
automatically populating said personal calendar with said at least one group event for each group to which said at least one member is subscribed; and
automatically forwarding email messages for each group to which said member is subscribed.

18. The computer implemented method of claim 17 wherein said displaying step includes displaying alerts, and wherein said method comprises the additional steps of:
polling a database to create a list of groups to which said member is subscribed;
polling said database to create a list of alerts from said list of groups to which said member is subscribed; and
displaying said list of alerts on a web page.

19. A method for digitally connecting a member to at least one group, the method comprising the automated steps of:
presenting said member with an opportunity to virtually join said at least one group;
receiving a command from said member representing said member's desire to associate with said at least one group;
associating said member with said at least one group, wherein said association is stored in a database;
presenting a personal calendar associated with said member, wherein said personal calendar is populated with at least one personal event for said member;
populating said personal calendar with an event associated with a calendar of said at least one group; and
forwarding an email message, from said at least one group, to said member, wherein said forwarding step comprises the steps of:
receiving a group addressed email message;
polling said database to identify subscribed members of said at least one group;
looking up a corresponding email address for each of said subscribed members; and
sending said group addressed email message to said corresponding email address.

20. The method of claim 19, further comprising the steps of:
polling a database to create a list of groups to which said member is subscribed;
polling said database to create a list of alerts from said list of groups to which said member is subscribed; and
displaying said list of alerts on a web page.

21. The method of claim 19 further comprising the step of displaying community news web objects.

22. The method of claim 19 further comprising the step of displaying a marketplace web object comprising at least one merchant group to which said member may subscribe.

23. The method of claim 19 further comprising the step of creating more than one member in the same household.

24. The method of claim 19 further comprising the step of displaying a homeowners association web page, wherein said homeowners association web page contains links to documents.

25. A method for connecting a community electronically comprising the steps of displaying the following web pages:
a web page for requesting to become a member of a community;
a web page for viewing available groups;
a web page for facilitating said member becoming a subscribed member of said available groups;
a web based email page configured to receive email forwarded to said subscribed member from a subscribed group; and
a web based personal calendar page, wherein said personal calendar is populated with events from a calendar of a group to which said member is subscribed.
